(19) United States
(12) Patent Application Publication
(10) Pub. No.: US 2002/0170290 A1
(43) Pub. Date: Nov. 21, 2002

(54) Multi-dimensional micro-electromechanical assemblies and method of making same

(76) Inventors: Victor Bright, Boulder, CO (US); Kevin Harsh, Arvada, CO (US); Paul Kladitis, New Carlisle, OH (US); Yc Lee, Boulder, CO (US); Wenge Zhang, Louisville, CO (US); Martin L. Dunn, Louisville, CO (US); Yanhang Zhang, Boulder, CO (US)

Correspondence Address: William J. Benman, Suite 2740, 2049 Century Park East, Los Angeles, CA, 90067, US

(21) Appl. No.: 10/138,763

(22) Filed: May 3, 2002

Related U.S. Application Data
(60) Provisional application No. 60/292,137, filed on May 18, 2001.

(51) Int. Cl. F02G 1/04; F01B 29/10

(52) U.S. Cl. 60/527; 60/528

(57) ABSTRACT

A multi-dimensional, micro-electromechanical assembly and the method of fabricating same. The invention enables an assembly of three-dimensional (3D) microelectromechanical systems (MEMS) using surface tension or shrinkage self assembly. That is, the invention provides a surface tension self assembly technique for rotating a MEMS element with a controlled amount of deformation to a selected angle out of the plane of a substrate. In accordance with the inventive method, multi-dimensional, micro-electromechanical assemblies are fabricated by providing a phase change material on at least one substantially planar structure mounted in a first orientation. A phase change is induced in the phase change material whereby the phase change material changes from a first state, in which the structure is disposed in the first orientation, to a second state, in which the structure is disposed in a second orientation. The MEMS elements may be fabricated using conventional surface micromachining techniques. In the illustrative embodiment, each MEMS element is attached to a substrate by at least one hinge which allows rotation of the MEMS element out of the plane of the substrate to a selected angle. To enable mass assembly of the MEMS elements, the MEMS elements are rotated to the selected angle using either surface tension forces of a liquid phase change material or shrinkage of a solid phase change material. In the illustrative embodiment, the phase change material is solder and the step of inducing a phase change in the phase change material includes the step up applying heat.

### CROSS REFERENCE TO RELATED APPLICATIONS

This application claims the benefit of a U.S. Provisional Application filed May 18, 2001, Serial No. 60/292,137 by Kevin Harsh, et al. for Controlled Surface Tension or Shrinkage Assembly of 3D MEMS.

### RIGHTS IN INVENTION

This invention is believed to have been made with U.S. Government support under the Department of Defense (MDA904-97-C-0320), the Defense Advanced Research Projects Agency (DARPA), the Air Force Research Laboratory, Air Force Materiel Command, USAF, agreement number F30602-98-1-0219.

### BACKGROUND OF THE INVENTION

1. Field of the Invention

The present invention relates to micro-electromechanical (MEMS) assemblies. More specifically, the present invention relates to systems and methods for fabricating MEMS assemblies.

2. Description of the Related Art

Micro-electromechanical structures are planar structures on a substrate in accordance with conventional integrated circuit fabrication techniques. Three dimensional micro-electromechanical structures (3D MEMS) are used to reflect energy and optical, microwave, fluidic and a variety of other applications. In an optical cross-connect switch used in a telecommunications application, for example, a micro-mirror may be required to steer a laser beam using a single microchip. This requires an array of mirrors that are normal to a surface. A conventional MEMS device could provide the array of mirrors, but they would be parallel to the surface and therefore incapable of steering a beam on command. However, for this application, a 3D MEMS structure could be used to achieve the desired beam steering requirement.

3D MEMS structures consist of planar surfaces which extend upwardly at various angles from a substrate. Conventionally, these devices are fabricated by manually by hand assembly. That is, fabrication of 3D MEMS typically requires a skilled technician to arrange planar structures under a microscope using micro-manipulators. In accordance with a conventional fabrication technique, a substrate of silicon or other certain material is provided onto which structures are built layer by layer using conventional thin-film manufacturing techniques. The structural layers, the layers from which the structures will be built, are supported by number of sacrificial layers. Between the application of success of thin-film layers, the underlying layer is patterned with a lithographic mask to define the geometry of the device. The sacrificial layers are removed in a chemical etching step. The results in a structure having a plurality of planar mechanical layers. Finally, a technician then uses micromanipulators and a microscope to make the horizontal structures sufficiently vertical in accordance with a given specification. Accordingly, this conventional technique for fabricating 3D MEMS structures provides a low yield of devices at high cost.

Another conventional technique for fabricating 3D MEMS structures in bands the assembly of planar materials with different coefficients of thermal expansion and the application of heat thereto. On the application of heat, the differences in the coefficients of thermal expansion cause certain predetermined surfaces to be elevated to a desired position. While encouraging results have been obtained under laboratory conditions, this technique has not yet been perfected so as to yield a large number of 3D MEMS devices manufactured to tight tolerances at low-cost.

Thus, a need remains in the art for an automated technique for manufacturing 3D MEMS in large quantities at low cost.

### SUMMARY OF THE INVENTION

The need in the art is addressed by the multi-dimensional, micro-electromechanical assembly and the method of fabricating same of the present invention. The invention enables an assembly of three-dimensional (3D) microelectromechanical systems (MEMS) using surface tension or shrinkage self assembly. That is, the invention provides a surface tension self assembly technique for rotating a MEMS element with a controlled amount of deformation to a selected angle out of the plane of a substrate.

In accordance with the inventive method, multi-dimensional, micro-electromechanical assemblies are fabricated by providing a phase change material on a substantially planar structure mounted in a first orientation on a substrate. A phase change is induced in the phase change material whereby the phase change material changes from a first state, in which the structure is disposed in the first orientation, to a second state, in which the structure is disposed in a second orientation.

In a specific illustrative embodiment, the inventive assembly includes a substrate; a MEMS element; at least one hinge connecting said MEMS element to said substrate; a first wettable pad attached to said MEMS element; a second wettable pad attached to said substrate, with the shape and location of said first and second wettable pads and the position and location of said hinge being selected together to provide the desired amount of deformation of said MEMS element; and a reflow material, the quantity of said reflow material being sufficient to rotate the MEMS element out of the plane of the substrate to a selected angle, said reflow material being placed so that it contacts both said first and said second wettable pads when said material is molten.

The MEMS elements may be fabricated using conventional surface micromachining techniques. In the illustrative embodiment, each MEMS element is attached to a substrate by at least one hinge which allows rotation of the MEMS element out of the plane of the substrate to a selected angle. To enable mass assembly of the MEMS elements, the MEMS elements are rotated to the selected angle using either surface tension forces of a liquid phase change material or shrinkage of a solid phase change material. In the illustrative embodiment, the phase change material is solder and the step of inducing a phase change in the phase change material includes the step up applying heat.

Although surface tension and shrinkage assembly of MEMS have been described previously by Green et al. and Syms (Green et al., Journal of Micro-electromechanical Systems, 4(4):170-176, December 1995; Syms, J. Microelectromechanical Systems, 8(4): 448-455, December 1999), the rotation angle precision of the previously described assembly techniques has been limited. The present invention provides improved surface tension and shrinkage assembly units and methods for making and using these surface tension and shrinkage assembly units. The present invention also provides improved methods of using mechanical rotation limiters. The methods of the invention can be used singly or in combination to improve rotation angle precision. The present invention also provides a method for shaping of MEMS elements, methods for sequentially assembling MEMS elements, and methods of using linkages to assemble multiple MEMS elements.

### BRIEF DESCRIPTION OF THE DRAWINGS

FIG. 1 is a top view of an illustrative embodiment of a multi-dimensional micro-electromechanical structure implemented in accordance with the teachings of the present invention.

FIG. 2 is a diagram showing a schematic side view of the multi-dimensional micro-electromechanical structure of FIG. 1 implemented in accordance with the teachings of the present invention before the reflow material is placed on the pads.

FIG. 3 is an SEM image which provides a close-up view of a staple hinge made using the MUMPs™, process in accordance with the teachings of the present invention.

FIGS. 4A and 4B are diagrams which illustrate the rotation of the hinged MEMS element away from the substrate during the assembly process of the present invention.

FIG. 5 shows the predictions of a simplified model for the effect of wettable pad aspect ratio (width/height) on the RMS plate deviation.

FIG. 6A shows the natural state of a MEMS plate without a wettable pad, where the plate bends back towards the substrate.

FIG. 6B shows a MEMS plate which is cupped forward around the solder (away from the substrate) due to stresses from the solder acting on the rectangular wettable pad.

FIG. 6C shows a MEMS plate flattened by pad shape specific stresses from the solder which counteract the plate deformation due to residual doping stresses in the polysilicon.

FIG. 7 shows the calculated RMS plate deflection versus hinge position for a variety of plate widths.

In FIG. 8A, the MEMS element has not yet been rotated away from the substrate.

As shown in FIG. 8B, as the reflow material rotates the MEMS element, the lock also rotates about its hinge and end slides along the surface of the MEMS element.

In FIG. 8C, the end of the lock has come to a “stop” on the MEMS plate and rotation of the plate stops at the desired angle.

FIG. 9A illustrates half of an assembly unit with two mechanical locks and two hinges in an ideal undeformed state in accordance with the teachings of the present invention.

FIG. 9B shows the calculated deformation of the same portion of the assembly unit resulting from the interaction of residual stresses resulting from device fabrication and the solder assembly process with the constraints imposed by the hinge and the mechanical lock.

FIG. 10 is a diagram showing a multi-dimensional, micro-electromechanical assembly fabricated by solidification and shrinkage using a rigid linkage to minimize deformation of an isolated MEMS element in accordance with an alternative embodiment of the teachings of the present invention.

FIG. 11 is a photograph showing a multi-dimensional, micro-electromechanical assembly fabricated by solidification and shrinkage using a rigid linkage connected to the top of first and second MEMS elements to minimize deformation of an isolated MEMS element in accordance with a second alternative embodiment of the teachings of the present invention.

FIG. 12 is a photograph showing a multi-dimensional, micro-electromechanical assembly fabricated using a more complicated structures in accordance with the teachings of the present invention.

FIG. 13A shows a structure before assembly in which a MEMS element is used as the substrate of a second multi-dimensional, micro-electro mechanical assembly in accordance with the teachings of the present invention.

FIG. 13B shows a side cross-sectional view of the structure of FIG. 13A assembled to a rotation angle of 90°.

FIGS. 14A and 14B are photographs showing a connection of three surface tension self assembly units to form a fiber optic cable gripper at high and low magnification, respectively, in accordance with the teachings of the present invention.

FIG. 15A shows one wettable pad design in accordance with the teachings of the present invention and FIG. 15C its corresponding solder profile.

FIG. 15B shows a second wettable pad design and FIG. 15D its corresponding solder profile.

FIG. 16 shows an example of a MEMS resistive heater used to assemble a simple MEMS plate.

FIG. 17A is a diagram showing one view of one normally closed (N.C.) and two normally open (N.O.) electrostatically actuated switches in accordance with the teachings of the present invention.

FIG. 17B is a diagram showing a top view of the switches of FIG. 17A.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

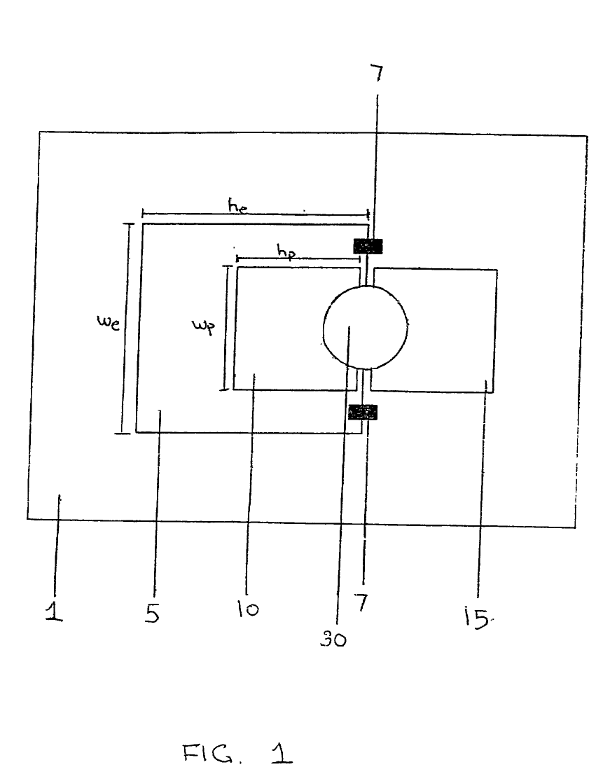

FIG. 1 is a top view of an illustrative embodiment of a multi-dimensional micro-electromechanical structure implemented in accordance with the teachings of the present invention. In accordance with the present teachings, a MEMS element (5) is attached to a substrate (1) via at least one hinge (7). A first wettable pad (10) is attached to the MEMS element (5) while a second wettable pad (15) is attached to the substrate (1). The width and height of MEMS element (5) (wₑ, hₑ) and the width and height of wettable pad (10) (wₚ, hp) are also shown in the drawing. A phase change or solid reflow material (30) is placed across the first and second wettable pads. A phase change is induced in the phase change material whereby the phase change material changes from a first state, in which the structure is disposed in the first orientation, to a second state, in which the structure is disposed in a second orientation. In the illustrative embodiment, the phase change material is solder and the step of inducing a phase change in the phase change material includes the step up applying heat. In accordance with the present teachings, the MEMS element (5) is rotated upward out of the plane of the substrate by melting the reflow material.

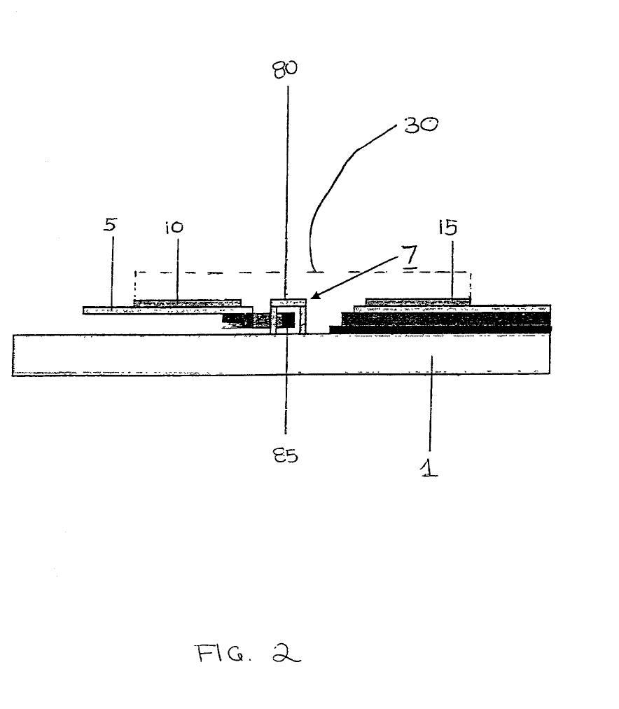

FIG. 2 is a diagram showing a schematic side view of the multi-dimensional micro-electromechanical structure of FIG. 1 implemented in accordance with the teachings of the present invention before the reflow material is placed on the pads. The placement of the solid reflow material (30) between and over portions of the two wettable pads (10, 15) is illustrated by a dotted line. The dotted line illustrates reflow material that has been deposited and patterned as a solid block across the pads. The MEMS element (5) extends over the substrate (1) from which it has been released by removal of sacrificial oxide layers.

In FIGS. 1 and 2, the substrate (1) is shown as a silicon micromachining substrate. Surface micromachining involves the deposition and patterning of several very thin layers of material that combine to form structures and mechanically moving parts. Typically, the structures and mechanically moving parts are made of polysilicon. The micromachining process also typically involves deposition of thin layers of sacrificial oxide material. After the desired structure is formed, the sacrificial oxide layers are removed, thereby “releasing” polysilicon parts designed to move. One standard surface micromachining process with which the present teachings may be used is known as Multi-User MEMS Processes or MUMPs™. This process is described in detail in the MUMPs™ Design Handbook, Revision 6.0 available from Cronos Integrated Microsystems, Research Triangle Park, North Carolina. The MUMPs™ process is a three-layer polysilicon surface micromachining process which uses deposited silicon nitride as electrical isolation between the polysilicon and a silicon substrate, deposited phosphosilicate glass for sacrificial layers and has a 0.5 micron thick metal layer as the final deposited layer in the process. The SUMMiT four-layer polysilicon process (Schriner, H. et al., “Sandia Agile MEMS Prototyping, Layout Tools, Education and Services Program”, 2^{nd} International Conference on Engineering Design and Automation, Maui, Hawaii, Aug. 9-12, 1998) can also be used to form the MEMS structures of the present invention. Those skilled in the art will appreciate that the present teachings and not limited to the process used to create the multilayer MEMS structure. Numerous other techniques, including those publicly known and those that are proprietary, without departing from the scope of the present teachings.

Returning to FIG. 2, the first wettable pad (10) is positioned on MEMS element (5). Also visible are a plurality of polysilicon layers from the micromachining process underneath wettable pad (15). Fewer polysilicon layers can be present than are shown in FIG. 2. The MEMS element is shown connected to the substrate by a plurality of hinges (7). The hinge seen in side view in FIG. 2 is a staple hinge with hinge cap (80) and hinge pin (85) shown.

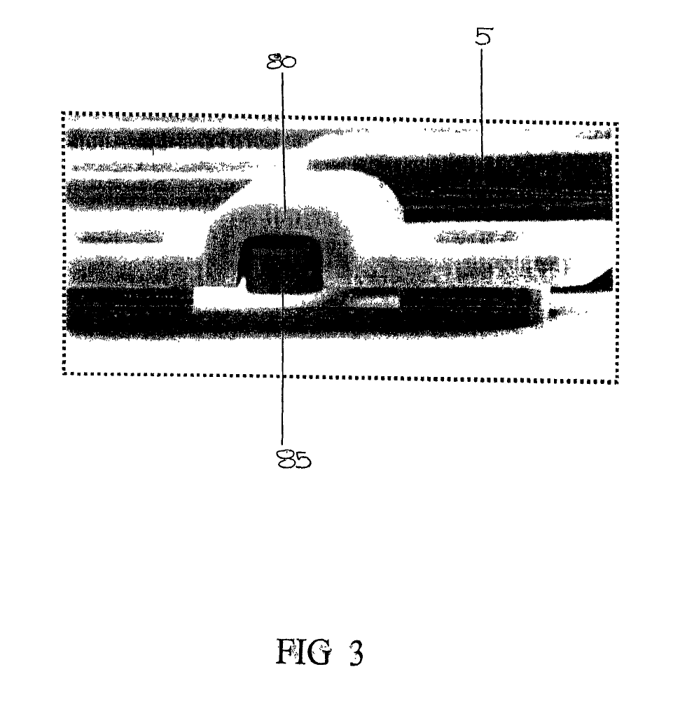

FIG. 3 is an SEM image which provides a close-up view of a staple hinge made using the MUMPs™, process in accordance with the teachings of the present invention. In FIG. 3, the hinge pin (85) is an extension of the MEMS element (5) and rotates within the hinge cap (80). The hinge cap (80) is anchored to the base layer of polysilicon, which in turn is anchored to a silicon nitride layer grown on the silicon substrate.

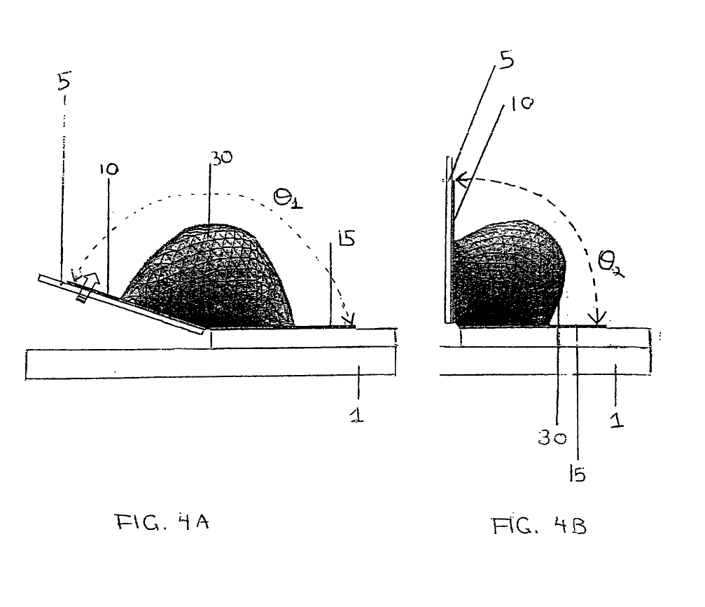

FIGS. 4A and 4B are diagrams which illustrate the rotation of the hinged MEMS element (5) away from the substrate (1) during the assembly process of the present invention. When the reflow material (30) is melted, the natural tendency of liquids to minimize their surface energy rotates the MEMS element (5). The white arrow in FIG. 4A shows the direction of movement of MEMS element (5). For simplicity, the hinges shown in FIGS. 1 and 2 are not shown in FIGS. 4A and 4B. As shown in FIGS. 4A and 4B, the rotation angle, θ, is defined as the angle between the planes of the first wettable pad (10) and the second wettable pad (15). FIG. 4A illustrates the rotation angle θ₁ at an early stage in the assembly process, while FIG. 4B illustrates the rotation angle θ₂ at equilibrium. The rotation angle can range between 0° and 180°.

Models for the surface energy of a molten reflow material are described in Harsh et al. and Kladitis et al. (Harsh et al., Sensors and Actuators A, 77, November 1999, 237 244; Kladitis et al., Proceedings of the 1999 ASME International Mechanical Engineering Congress and Exposition (ICME '99), Nashville, Tenn., Vol. 1, pp. 11-18, Nov. 14-19, 1999). When the reflow material is resolidified by cooling, the hinged MEMS element is held out of the plane of the substrate.

It has been found that solidification and subsequent cooling of the reflow material introduces stresses strong enough to deform the MEMS element. The present invention provides improved surface tension self assembly units which modify the deformation of the MEMS element induced by solidification and cooling of the reflow material. In accordance with the present teachings, the shape and location of the wettable pads on the MEMS elements and the number and location of the hinges attaching the MEMS elements to the substrate are selected to appropriately modify the deformation of the MEMS element induced by solidification and cooling of the reflow material. The inventive micro-electromechanical units can optionally include a mechanical lock, having a location which is also appropriately selected to modify the deformation of the MEMS element. The selection of hinge, wettable pad, and mechanical lock parameters are discussed in more detail below.

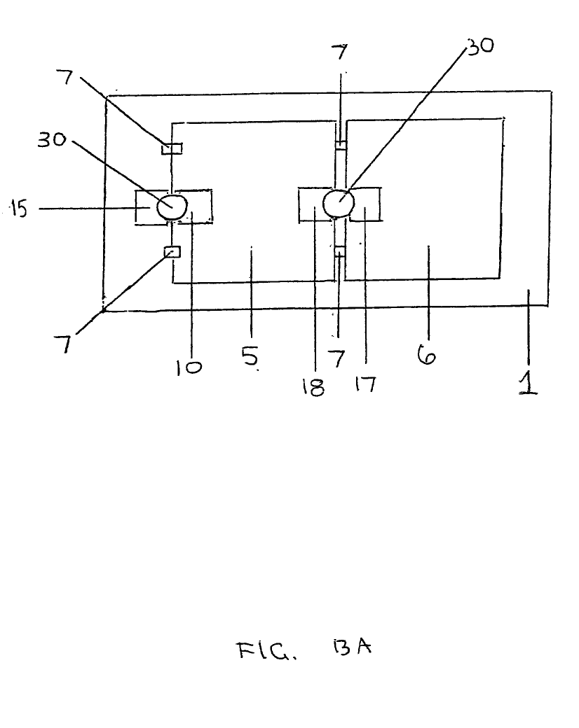

Returning to FIGS. 1 and 2, in general, the hinges (7) and the second wettable pad (15) are not connected directly to the silicon substrate, but are connected to the substrate by polysilicon and other layers deposited during the micromachining process. However, it is also possible for the substrate to be another hinged MEMS element (as shown below in FIGS. 13A and 13B). Several types of hinges may be used to connect the MEMS element to the substrate without departing from the scope of the present teachings, including substrate or staple hinges which attach directly to the first polysilicon layer or the nitride layer on the silicon micromachining substrate (MUMPs™ process), scissors hinges which connect two MEMS elements together, and flexible strips of polysilicon (flexures) which can be used with either type of substrate.

The MEMS element (5) may have etch holes through the element or dimples on the silicon substrate side of the element to improve reliability of the release process. If the reflow material (30) is solder, the wettable pads are solder wettable pads metallized on the MEMS element and substrate. With the MUMPs™ process, the solder wettable pads are made of gold attached to the MEMS element and the substrate via a Cr adhesion layer. Nickel or copper pads solder wettable pads can also be used.

Numerous phase change or “reflow materials” may be used without departing from the scope of the present teachings including tin-lead and indium-lead solders. Theoretically any solid which melts at a convenient process temperature can be used. 63 Sn/37 Pb, 60 In/40 Pb, and pure indium have been used to assemble MEMS elements using surface tension self assembly. The melting temperature of the solid should be above the expected use temperature of the MEMS, but below temperatures at which MEMS damage occurs. For example, above approximately 250° C., cracking of polysilicon and gold structures is known to occur (Bums, D. and Bright, V., 1997 International Conference on Solid-State Sensors and Actuators (Transducers -97), Chicago, Ill., 1997. pp. 335-338).

One important consideration in selecting a reflow material is the extent of solidification shrinkage, which affects the deformation of the MEMS element during solidification and cooling of the reflow material. The extent of reaction between the wettable pad material and the reflow material should also be considered, since extensive reaction can lead to significant changes in the reflow material composition or extensive intermetallic formation. In addition, it is desirable to be able to control oxide formation on the liquid reflow material surface during the assembly process, since the surface energy of a reflow material with a thick oxide layer is generally different from that of the same reflow material with little or no oxide layer. One method of controlling oxide formation on molten solder is to use a reactive gas soldering system (Tan, Q. and Lee, Y. C., IEEE Transactions on Components, Packaging and Manufacturing Technology, Part C, May 1996, pp. 28-30). A gas mixture of nitrogen and from 0.66-1.7 atomic percent formic acid has been found effective for 63 Sn/37 Pb solder. The reflow material can be placed on the wettable pads before or after release of the MEMS element. If solder balls are used for the reflow material, they may be placed on the wettable pads using a micropositioner. If solder balls are placed on the wettable pads before the release step, the solder should be pre-flowed so that it adheres to the wettable pads during the release step.

The shape of the first (10) and second (15) wettable pads, the location of the first wettable pad on the MEMS element and the number and position of the hinges connecting the MEMS element to the substrate all affect the way in which solidification and shrinkage of the reflow material deform the MEMS element. The affect of the wettable pad and hinge parameters listed above on the extent and type of deformation of the MEMS structure can be calculated using a finite element model. For a simplified assembly unit, the MEMS element is a rectangular plate, the pad can be limited to rectangular shapes and the number of hinges can be limited to two. In this case, the parameters to be varied are the width and height of the solder pad and the position of the hinge.

Programs suitable for solving the finite element model include the ABAQUS program, available from Hibbitt, Karlsson and Sorenson, Inc. With the ABAQUS program, model definition must be provided by the user. This can be done several ways, the simplest being typing out the ABAQUS input definition by hand. A graphical model building tool that can generate input files for the solver tool can also be used. Suitable graphical model building software includes the PATRAN program, available from MSC software. The PATRAN software has an auto-meshing feature which automatically chooses the best mesh for the geometry.

To find the optimum wettable pad and hinge parameters, preexisting algorithms can be used. One suitable algorithm is NLPQL, a FORTRAN optimization code (K. Shittkowski, Annals of Operations Research, 5(6):485-500, 1985). The optimization process starts with an initial guess for the wettable pad and hinge parameters and a set number of constraints and variables. The finite element model is evaluated for this initial guess. In addition, the derivative of the function with respect to each parameter is evaluated. The derivative can be found using the finite difference method. The NLPQL program uses the function evaluation, the function derivatives, and the constraint equation derivatives to predict new wettable pad and hinge values. The optimization process stops when convergence to a user defined specification is achieved. To optimize the plate flatness, the combined results of root mean square (RMS) deflection of the MEMS element, average deflection of the element, and maximum deflection across the surface of the element are optimized. These values were chosen because combined they provide a good depiction of deformation of the element. For example, it is possible that an element deformed in a symmetric way could have an average deflection of zero, without being considered flat. Similarly, an element with a sharp peak in a concentrated area could still have a low average and RMS deflection value.

The wettable pad essentially defines the region in which the primary deflection inducing stress occurs. Therefore, it is intuitive to make the pad as small as possible. However, it is not currently practical to make wettable pads smaller than about 2500 square microns when solder spheres are used as the reflow material.

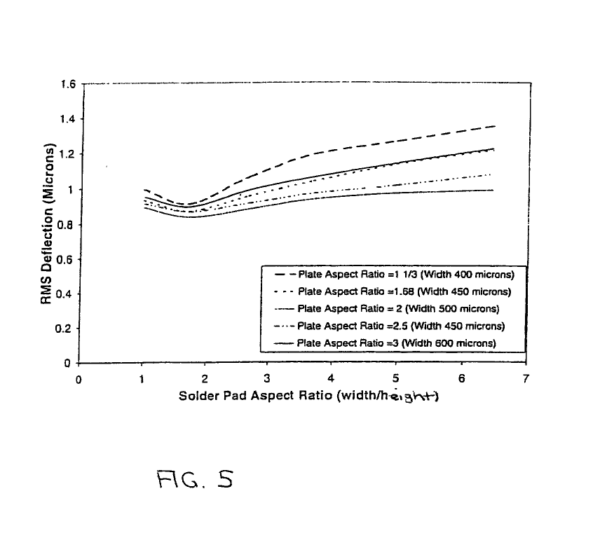

FIG. 5 shows the predictions of a simplified model for the effect of wettable pad aspect ratio (width/height) on the RMS plate deviation. The simplified model has a MEMS element which is a rectangular plate, rectangular wettable pads, and two symmetrically placed hinges. The plate area is fixed at 180,000 square microns and the pad area is fixed at 16,900 square microns. The model predicts a minimum in the RMS plate deflection for solder pad aspect ratios between 1.5 and 2.

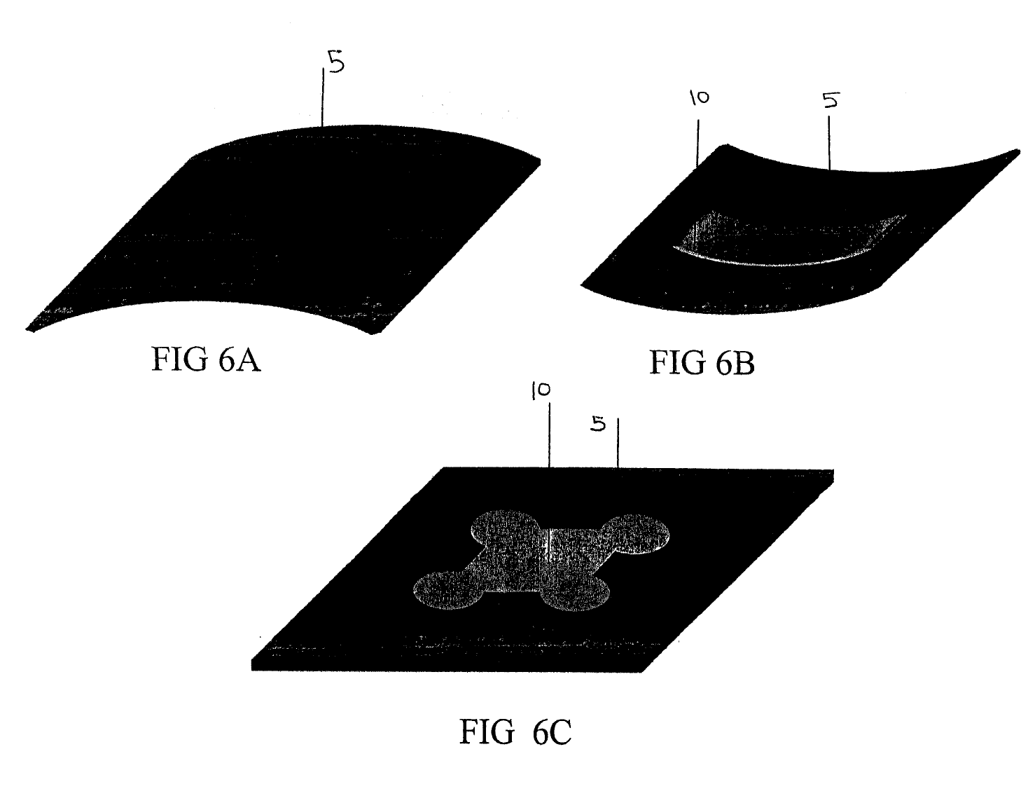

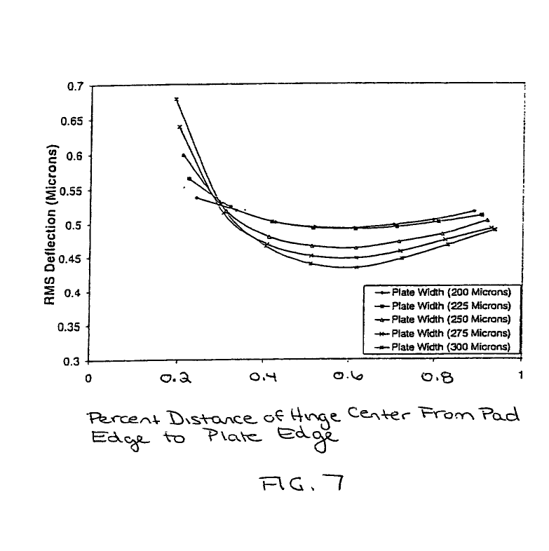

FIGS. 6A, 6B, and 6C schematically illustrate the effects of wettable pad shape on a free polysilicon plate (hinge effects ignored). Since a free plate is difficult to fabricate, the plate deformation was calculated for a plate which is point fixed at its center to a substrate. FIG. 6A shows the natural state of a MEMS plate (5) without a wettable pad, where the plate bends back towards the substrate. The warpage is a result of the residual doping stresses in the polysilicon. FIG. 6B shows a MEMS plate (5) which is cupped forward around the solder (away from the substrate) due to stresses from the solder acting on the rectangular wettable pad. FIG. 6C shows a MEMS plate (5) flattened by pad shape specific stresses from the solder which counteract the plate deformation due to residual doping stresses in the polysilicon.

For a simplified model with a rectangular plate MEMS element, rectangular wettable pads, and two symmetrically placed hinges, the model predicts that the optimum hinge position is more dependent on plate width than on plate height.

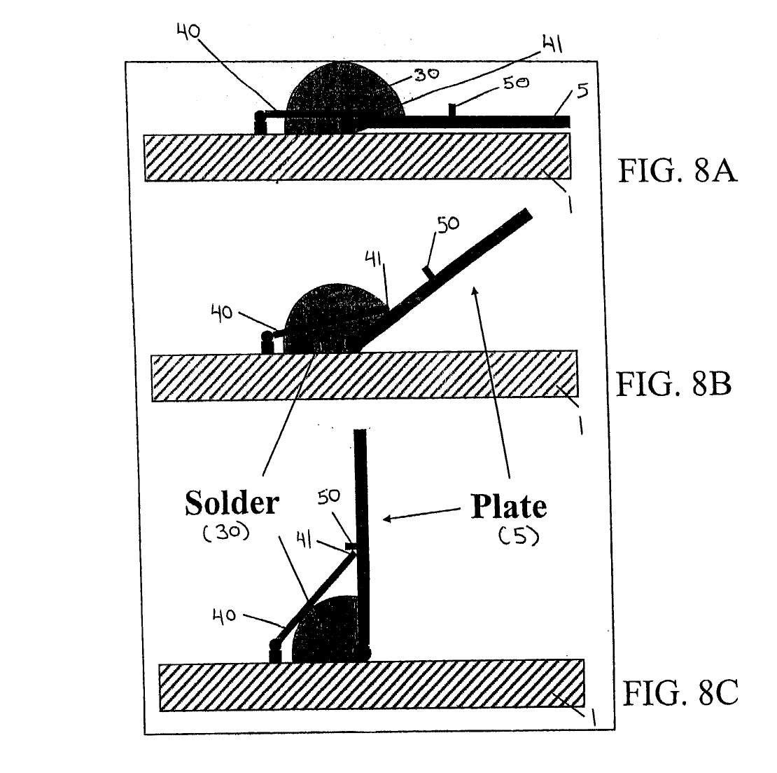

FIG. 7 shows the calculated RMS plate deflection versus hinge position for a variety of plate widths. The hinge position is plotted in terms of its percent distance from the pad edge to the plate edge. FIG. 7 shows that the optimum hinge position in this case is when the center point of the hinge is located approximately 55 to 60 percent of the distance from the pad edge to the plate edge. The number of hinges also affects the plate deformation. In general, more hinges reduce the deformation of the plate from its ideal shape and angle.

In the best mode, the invention also includes a mechanical lock which stops rotation of the MEMS element at the desired angle. Further, the location of the mechanical lock is preferably optimized to provide the desired MEMS element deformation. One type of lock useful in controlling rotation angle is a “kickstand lock”, such as that shown in FIGS. 8A-8C.

In FIG. 8A, the MEMS element (5) has not yet been rotated away from the substrate (1). The kickstand lock (40), which is attached to the substrate (1) by a hinge, rests on top of the MEMS element. The end of the lock opposite the hinge has been labeled (41).

As shown in FIG. 8B, as the reflow material (30) rotates the MEMS element, the lock (40) also rotates about its hinge and end (41) slides along the surface of the MEMS element.

In FIG. 8C, the end of the lock (41) has come to a “stop” (50) on the MEMS plate (5) and rotation of the plate stops at the desired angle. In FIGS. 8A-8C., the stop (50) is shown as a projection on the MEMS element (5), but the stop can also be a hole or slot in the MEMS element. The presence of the lock will modify the deformation of the MEMS element caused by the solidification and shrinkage of the reflow material on the first wettable pad, since it will resist the element being pulled towards the wettable pad on the substrate by solidification and shrinkage forces.

The affect of the mechanical lock location, along with wettable pad and hinge parameters, on the extent and type of deformation of the MEMS element can be calculated using a finite element model like that described above. The mechanical lock location is defined as the location at which the lock end (41) contacts the MEMS element when the lock engages. Contact restrictions are required for the lock in the finite element model. For a kickstand lock, the contact surface was chosen to be a cylindrical surface, centered at the lock base position, and with the radius being the lock length.

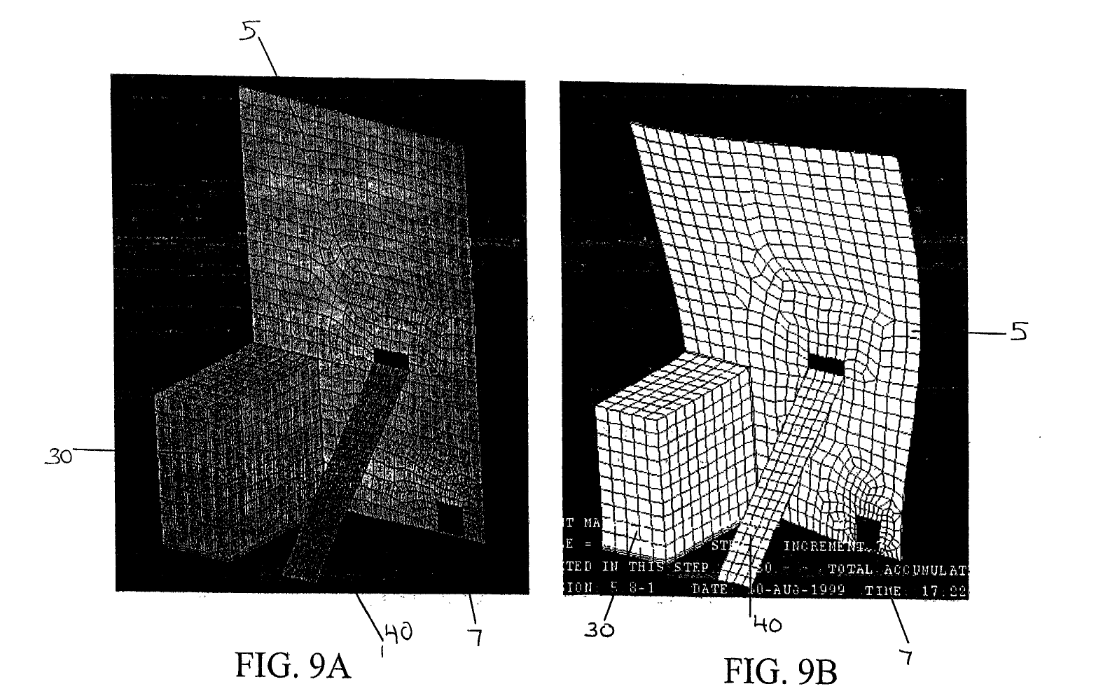

FIG. 9A illustrates half of an assembly unit with two mechanical locks and two hinges in an ideal undeformed state in accordance with the teachings of the present invention. In FIG. 9A the left edge of the portion of the assembly unit is the centerline of the assembly unit. The finite element model adjusted for the presence of the mechanical locks can be used to optimize the shape of the MEMS element as before.

FIG. 9B shows the calculated deformation of the same portion of the assembly unit resulting from the interaction of residual stresses resulting from device fabrication and the solder assembly process with the constraints imposed by the hinge and the mechanical lock.

For a simplified model with a rectangular plate MEMS element, rectangular wettable pads, two symmetrically placed hinges, and two symmetrically placed locks, the model predicts the following rough design rules.

First, the lock should not be placed adjacent to the solder pad. If the distance between the lock contact point and the fixed edge of the solder pad is relatively small, the plate curvature between the lock contact point and the edge of the solder pad is relatively large, resulting in a relatively large plate deformation in the horizontal axis.

Second, the lock should be positioned above the upper edge of the pad. For example, if the pad height is 130 microns, the lock should be positioned somewhere between 130 microns and the top of the plate.

Third, the horizontal position of the hinge should be at least 60 percent of the distance from the pad edge to the plate edge. It is possible to incorporate more than two mechanical locks into the design structure for the purposes of reducing plate deformation by constraining the plate in more places.

Surface tension self assembly units made using the above methods offer improved control of the rotation angle. Use of the surface tension self assembly units of the invention may reduce deformation induced deviations in the rotation angle to 0.1 degrees. In addition to reducing deviations in the rotation angle, reduction of MEMS element deformation is critical for applications demanding retention of a particular shape, such as planar mirrors.

The invention also provides shrinkage self assembly units. The shrinkage self assembly unit is similar to the surface tension self assembly unit described above, except that a shrinkage material is substituted for the reflow material. Suitable shrinkage materials include polymers which shrink upon cross-linking or when solvent is driven out, including AZP4620 photoresist.

The invention also provides a method of making a MEMS element extending upward at a fixed angle θ from a substrate surface comprising the steps of: choosing a set of parameters related to the MEMS element and other elements of the self assembly unit used to rotate the MEMS element out of the plane of the substrate; calculating a set of optimized self assembly unit parameters based on the chosen set of parameters; fabricating the MEMS element and the self assembly unit using the chosen and optimized parameters; depositing the reflow material; melting the reflow material; and cooling the reflow material. More specifically, the method comprises the steps of: selecting the dimensions of the MEMS element, the angle θ, and the desired final shape of the MEMS element; selecting the number and type of hinges used to connect the MEMS element to the substrate; selecting a reflow material to be used for surface tension self assembly of the MEMS element; calculating the amount of reflow material required to rotate the MEMS element to the angle θ; calculating the location of hinges connecting the MEMS element to the substrate and the shape and location of wettable pads on the MEMS element and on the substrate required to produce the desired final shape of the MEMS element; fabricating the MEMS element, the hinges connecting the MEMS element to the substrate, and the wettable pads on the MEMS element and the substrate; depositing the reflow material on the wettable pads; melting the reflow material, thereby assembling the MEMS element; and cooling the reflow material. The method for calculating the amount of reflow material is discussed in Harsh et al. (“Solder self-assembly for three dimensional micro-electromechanical systems, Sensors and Actuators A, 77, November 1999, 237-244). The cooling step must solidify the reflow material.

A mechanical lock may also be used to control the rotation angle of the MEMS element. In this case, the step of choosing a set of parameters related to the MEMS element and other elements of the self assembly unit used to rotate the MEMS element out of the plane of the substrate includes choosing the width of the mechanical lock. Typical mechanical lock widths are on the order of 10 microns. The step of calculating a set of optimized self assembly unit parameters based on the chosen set of parameters includes choosing the location of the mechanical lock with respect to the MEMS element. Finally, the step of fabricating the MEMS element, the hinges and the wettable pads includes fabrication of the mechanical lock.

Those skilled in the art will appreciate that by appropriate selection of the surface tension self assembly unit parameters, the present invention also provides a method of limiting deformation induced variation in the rotation angle of a planar MEMS element. A mechanical lock is not required to achieve a specified degree of angle control if the volume of solder is well controlled and intermetallic effects are negligible.

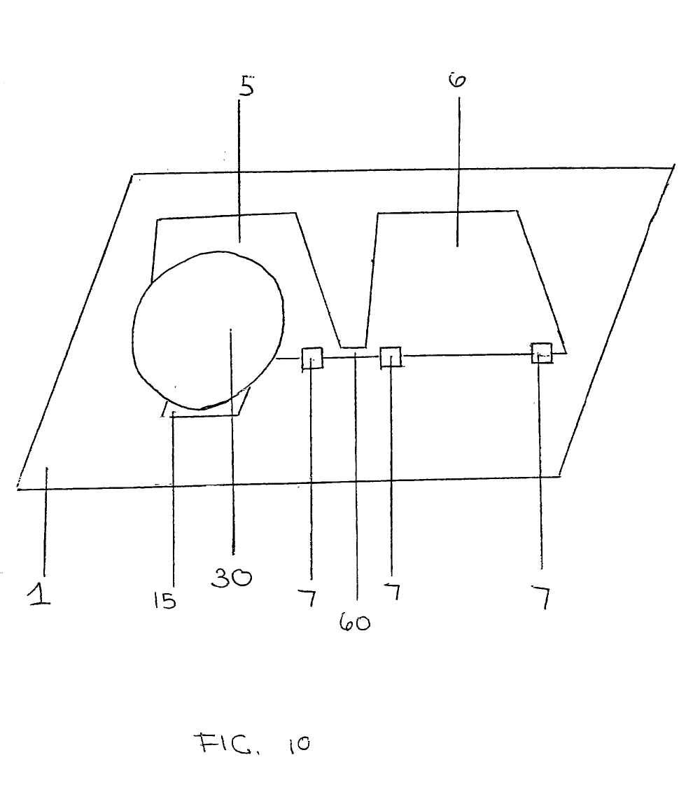

A surface tension self assembly unit can be connected with rigid linkages to one or more MEMS elements connected to the same substrate. A rigid linkage provides a way of minimizing deformation of a MEMS element by solidification and shrinkage of the assembly unit reflow material by isolating the MEMS element from the surface tension self assembly unit as illustrated schematically in FIG. 10.

FIG. 10 is a diagram showing a multi-dimensional, micro-electromechanical assembly fabricated by solidification and shrinkage using a rigid linkage to minimize deformation of an isolated MEMS element in accordance with an alternative embodiment of the teachings of the present invention. In FIG. 10, a first MEMS element (5) is part of a surface tension self assembly unit, as before. The first MEMS element (5) is in turn connected to a second MEMS element (6) by a rigid linkage (60). Both the first MEMS element (5) and the second MEMS element (6) are connected to the same substrate (1) by hinges (7). The linkage (60) should be sufficiently thin so that any deformation of the first MEMS element is not substantially transmitted to the second MEMS element. The linkage (60) should be sufficiently rigid that the rotation angle of the surface tension self assembly unit is the same as that of the MEMS element. In practice, a polysilicon linkage of cross-sectional areas 2 microns wide by 1.5 microns thick has been found to be sufficiently rigid to transmit the angle of rotation to MEMS elements of any dimension. Nonetheless, those of ordinary skill in the art will appreciate that the present teachings are not limited to these dimensions. A linkage need not be connected to the side of the MEMS element as was illustrated in FIG. 10.

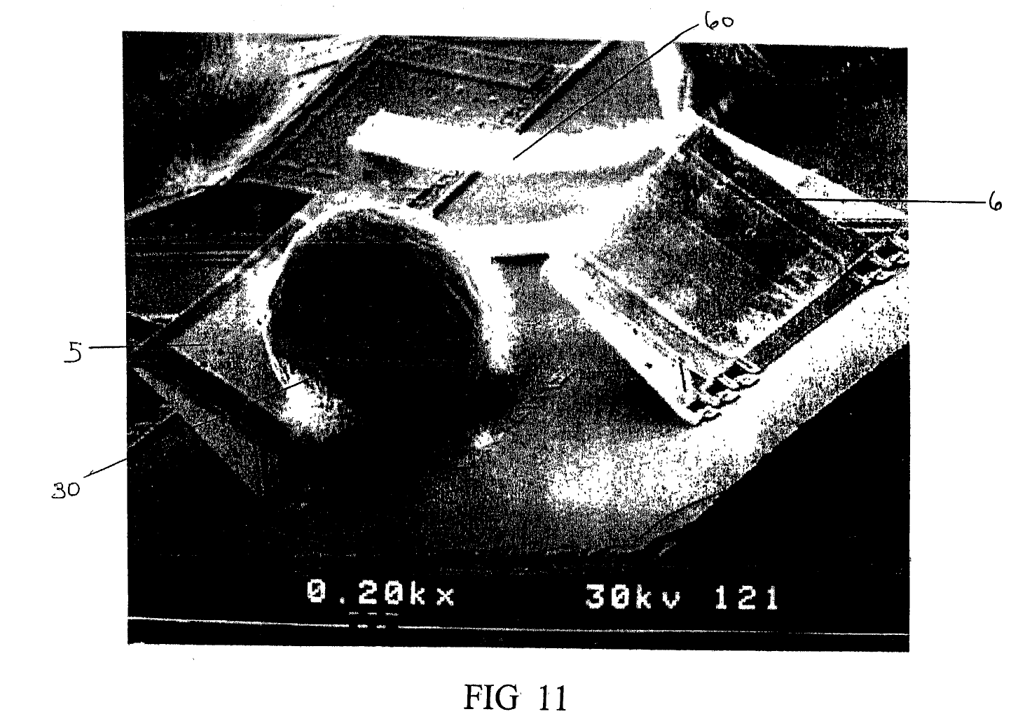

FIG. 11 is a photograph showing a multi-dimensional, micro-electromechanical assembly fabricated by solidification and shrinkage using a rigid linkage connected to the top of first and second MEMS elements to minimize deformation of an isolated MEMS element in accordance with a second alternative embodiment of the teachings of the present invention. The second MEMS (6) element may have a pad placed on it for the purposes of shaping the MEMS element. If no reflow material is placed on the pad, the MEMS element is shaped by the forces generated by the CTE (coefficient of thermal expansion) mismatch between the MEMS element and the pad material in combination with the affects of any hinges or mechanical locks associated with the MEMS element. In this case, the pad shape and location required to achieve the desired MEMS element shape are calculated using a model similar to that described previously for the surface tension self assembly unit. However, forces due to CTE mismatch between the MEMS element and a reflow material are omitted since no reflow material is present. If a reflow material is placed on a wettable pad on the MEMS element, the shaping of the MEMS element can be calculated with the surface tension self assembly model, modified appropriately for any changes in the reflow material distribution.

The invention also provides a method for using a surface tension self assembly unit to rotate at least two MEMS elements to a selected angle. The first MEMS element is part of the surface tension self assembly unit. The second MEMS element is attached to the same substrate as the surface tension self assembly unit with one or more hinges. A rigid linkage connects the first MEMS element to the second MEMS element. When the first MEMS element rotates to the selected angle, the second MEMS element rotates to the same angle. FIGS. 10 and 11 show two examples. If the linkage deforms slightly, there may be slight difference between the rotation angle of the first and second MEMS elements.

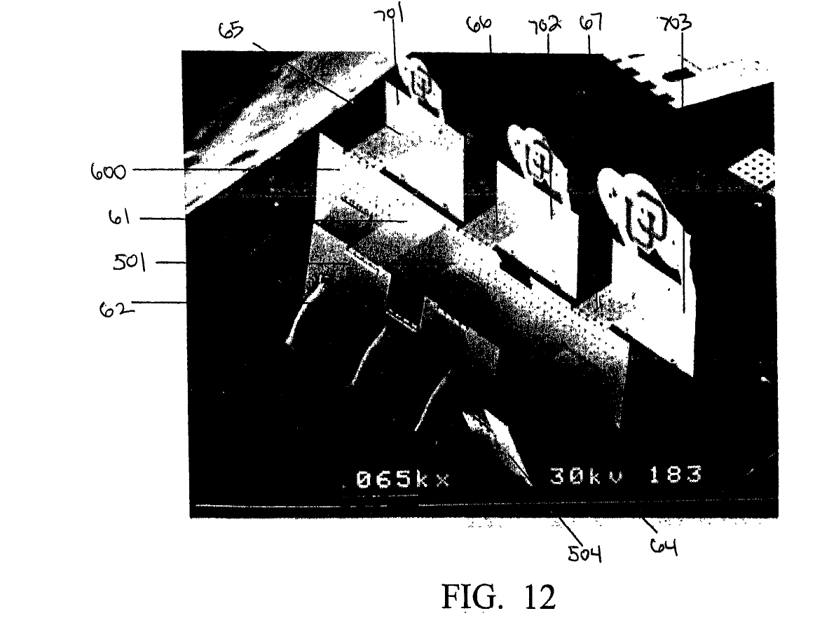

To rotate more than two MEMS elements to the selected angle, more than one rigid linkage can be used. For example, if the surface tension assembly unit shown in FIG. 10 is connected to a third MEMS element by a rigid linkage attached to the left side of the first MEMS element, the surface tension self assembly unit will rotate all three MEMS element to the same rotation angle. Side and top linkages can be used in combination and/or multiple assembly units can be used to assemble more complicated structures as shown in FIG. 12.

FIG. 12 is a photograph showing a multi-dimensional, micro-electromechanical assembly fabricated using a more complicated structures in accordance with the teachings of the present invention. In FIG. 12, there are three surface tension self assembly units visible at the left side of the photo. The three self assembly units have a common MEMS element (501). Linkage (61) connects the top of element (501) to element (600), while linkage (62) connects the top of element (501) to element (600) below the top of element (600). As element (501) is rotated out of the plane of the substrate, element (600) is pulled up out of the plane of the substrate by the linkages (61)and (62). As element (600) rotates out of the plane of the substrate, linkage (64) pushes up element (504) and linkages (65), (66), and (67) pull up elements (701), (702), and (703) respectively. Linkages (65), (66), and (67) are said to act in parallel since they are attached to a common element (600) that provides the lifting action for elements (701), (702), and (703). However, linkages (61) and (66) are said to act in series since element (501) provides the lifting action for element (600), which in turn provides the lifting action for element (702).

The MEMS element of a surface tension self assembly unit can also be used as the substrate of a second surface tension self assembly unit, as shown in FIGS. 13A and 13B.

FIG. 13A shows a structure before assembly in which a MEMS element is used as the substrate of a second multi-dimensional, micro-electro mechanical assembly in accordance with the teachings of the present invention. In FIG. 13A, the first surface tension self assembly unit comprises the substrate (1), the first MEMS element (5) connected to the substrate via hinges (7), a first wettable pad (10) connected to the first MEMS element (5), a second wettable pad (15) connected to the substrate, and a reflow material (30) placed across the first and second wettable pad. The second surface tension self assembly unit comprises the first MEMS element (5), the second MEMS element (6) connected to the first MEMS element (5) via hinges (7), a third wettable pad (17) connected to the second MEMS element (6), a fourth wettable pad (18) connected to the first MEMS element (5), and a reflow material (30) placed across the third and fourth wettable pad. Note that the second MEMS element (6) is not fixed to the substrate (1).

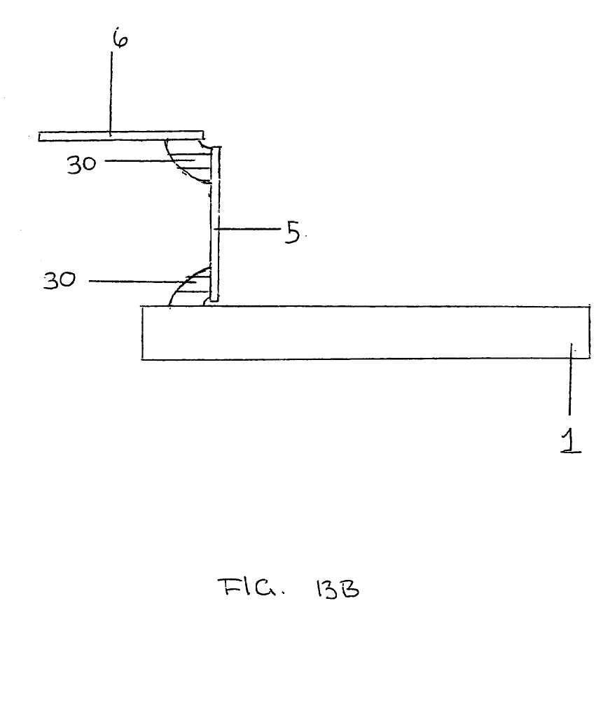

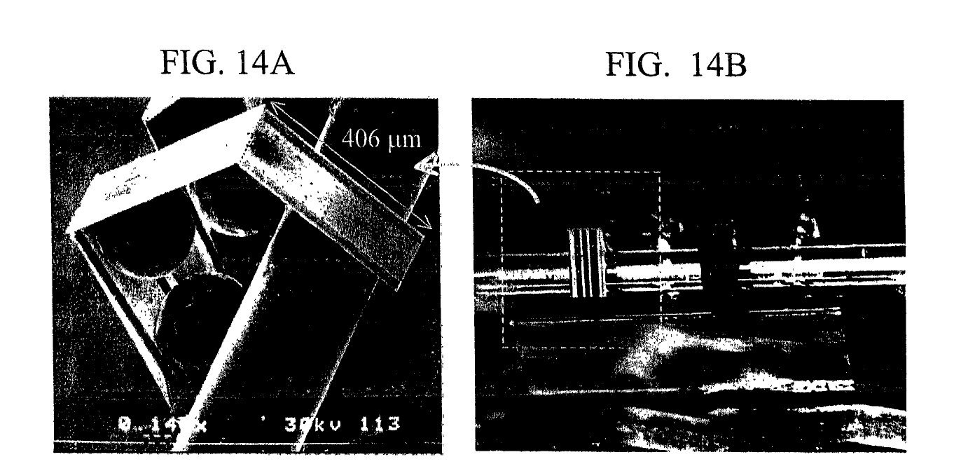

FIG. 13B shows a side cross-sectional view of the structure of FIG. 13A assembled to a rotation angle of 90°. In FIG. 13B, the hinges (7) are not shown. FIG. 13A is similar to part of the CAD design layout in FIG. 6 in Harsh et al. for making a box with a lid (Proceedings of the 44^{th} International Instrumentation Symposium, Reno, NV, May 3-7, 1998, pp. 256-261). However, Harsh et al. were not successful in fabricating their box design to an assembly angle of 90° using thin flexible pieces of polysilicon as hinges. Successful fabrication of even more complicated assembled structures may be accomplished by careful selection of the hinge length and by modifying the fabrication process. In general, the hinge length needs to allow for the amount of hinge folding imposed by the rotation angle, with smaller rotation angles requiring greater hinge folding. However, as the hinge length increases, the rotation point is less constrained, so the hinge length should not greatly exceed that required that required by the rotation angle. The fabrication process was modified by placing the solder balls on the wettable pads and pre-melting the solder so that it bonds to the wettable pads prior to release of the MEMS structures. This procedure prevents solder balls from rolling off the wettable pads as the structure begins to assemble. This is illustrated in FIGS. 14A and 14B below.

FIGS. 14A and 14B are photographs showing a connection of three surface tension self assembly units to form a fiber optic cable gripper at high and low magnification, respectively, in accordance with the teachings of the present invention. The invention provides a method of sequentially surface tension self assembling at least two MEMS elements in a selected order comprising the steps of: choosing a set of parameters related to the first and second MEMS elements and other elements of the first and second self assembly units used to rotate the MEMS elements out of the plane of the substrate; calculating optimized wettable pad shapes for the first and second self assembly units based on the chosen set of parameters so that the MEMS elements assemble in the selected order; fabricating the first and second MEMS elements and self assembly units using the chosen and optimized parameters; depositing the first and second reflow materials; melting the reflow materials; and cooling the reflow materials.

More specifically, the method comprises the steps of: selecting the dimensions of the first and second MEMS elements, the first and second rotation angles θ, the desired final shape of the MEMS elements, and the number and location of hinges connecting the first and the second MEMS elements to the substrate; selecting at least one wettable pad material for the wettable pads on the first and second MEMS elements and the substrate; selecting a first and a second reflow material to be used for surface tension self assembly of the first and second MEMS element, respectively; calculating the amount of reflow material required to rotate each element to its selected angle θ; calculating the shape and location of the optimized wettable pad shapes for the first and second self assembly units based on the chosen set of parameters; fabricating the first and second MEMS elements and self assembly units using the chosen and optimized parameters; depositing the first and second reflow materials; melting the reflow materials; and cooling the reflow materials.

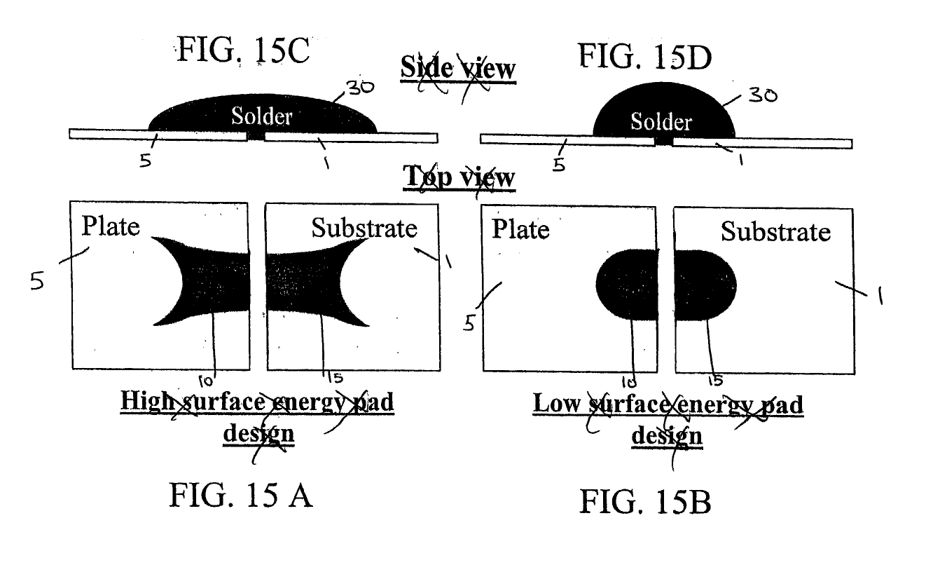

The shape of the wettable pads on the MEMS element and the substrate influences the shape and thus the surface energy of the molten reflow material in the assembly unit. The surface energy of the molten reflow material is related to the surface tension forces exerted by the molten reflow material. Because the molten material has viscous properties, the speed at which the liquid changes shape, and therefore the speed at which the MEMS plates are assembled, depends on the surface tension forces exerted by the molten reflow material which in turn are related to the reflow material surface energy and wettable pad shapes. FIGS. 15A-15D illustrate sequential assembly achieved by using energy specific pad designs.

FIG. 15A shows one wettable pad design in accordance with the teachings of the present invention and FIG. 15C its corresponding solder profile.

FIG. 15B shows a second wettable pad design and FIG. 15D its corresponding solder profile. Even though both MEMS plates are identical, and the same solder material and volume are used for both designs, the pad design in FIG. 15A will result in a higher surface energy. Therefore, the plate in FIG. 15A will assemble before the plate in FIG. 15B.

Another way of creating sequential assembly is to use two reflow materials with similar melting points but different surface energy coefficients combined with properly designed energy specific pad shapes. If two different reflow materials are used, potential complications due to inter-metallic reactions, chemical reactions, and material reliability should be considered. Use of two such reflow materials without specially designed pad shapes can also be sufficient to provide sequential assembly.

The invention also provides a method of sequentially surface tension self assembling MEMS devices comprising the steps of: providing at least two surface tension self assembly units, each having a MEMS element; providing first and second microheating elements for melting the reflow material in the surface tension self assembly units; selecting the desired assembly order of the MEMS elements; sequentially melting the first and second reflow materials using said first and second microheating elements so that MEMS elements assemble in the desired order; and cooling the first and second reflow materials. The cooling step comprises turning off the microheating elements.

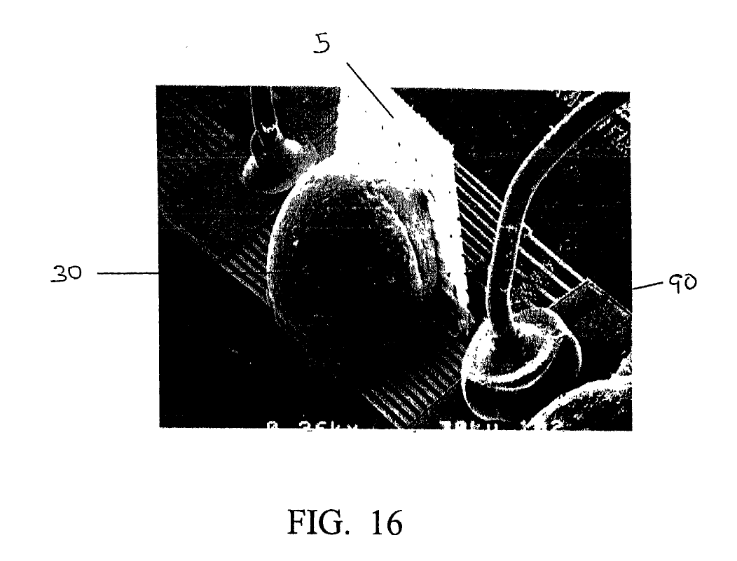

FIG. 16 shows an example of MEMS resistive heater used to assemble a simple MEMS plate. The time sequence of assembly can be controlled very well when microheaters are used to perform sequential assembly because each assembly step can be triggered electrically. Since each heater element will require its own independent electrical connections, the number of wire connections required may be unreasonable for large or extremely complex assembly systems. To simplify the assembly system, the heater elements could be combined with the energy specific pad design and use of reflow materials with different properties as discussed above. Alternatively, one heated element can assemble other MEMS elements using linkages.

Another way of causing the first MEMS element to be assembled before the second MEMS element is to select the second reflow material to have a higher melting temperature than the first reflow material. However, the MEMS device assembly may be adversely sensitive to the additional thermal loading introduced by having reflow materials with two different melting points.

The three-dimensional micro-electromechanical systems of the invention offer: rapid assembly of complex three-dimensional MEMS structures, the capability to make hundreds or thousands of precision alignments with a single batch reflow process, reduction of cost/alignment by orders of magnitude, excellent thermal, electrical, and mechanical connections, and repeatable high precision, alignment of rotated hinged structures. Moreover, the small individual mass of the micromachined devices leads to superior ruggedness and fast system response time, making MEMS ideal for a variety of military and commercial applications.

One key application of the MEMS of the invention is as optical components. The ability to control the deformation of the MEMS element allows for fabrication of mirrors with improved planarity and structural rigidity and also for fabrication of such components as concave lenses. In addition, the methods of the invention can be used to assemble one or more corner cube reflectors, which can act as optical communication links.

The methods of the invention can also be used to fabricate several other devices. Two such devices are fiber optic grippers (as shown in FIGS. 14A and 14B) and antennae. Good angle control of microrobot legs allow the robot to move properly by having properly positioned legs. The invention can also be used to make solder assembled cubes and pyramids to provide packaging (enclosure) of MEMS devices. Precise angle control over MEMS elements also allows the fabrication of electrostatically actuated switches.

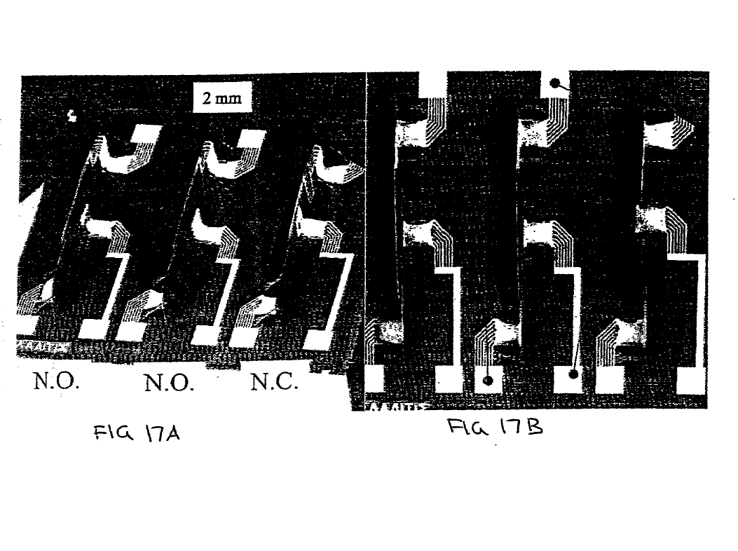

FIG. 17A is a diagram showing one view of one normally closed (N.C.) and two normally open (N.O.) electrostatically actuated switches in accordance with the teachings of the present invention.

FIG. 17B is a diagram showing a top view of the switches of FIG. 17A. Each switch consists of two contact plates and one attraction plate. One of the contact plates can flex upon the application of electrostatic force between it and the attraction plate, allowing making or breaking of its contact to the other contact plate.

Thus, the present invention has been described herein with reference to a particular embodiment for a particular application. Those having ordinary skill in the art and access to the present teachings will recognize additional modifications applications and embodiments within the scope thereof. For example, a device may be fabricated in accordance with the present teachings by which the phase change material is deposited between a planar structure and a substrate.

It is therefore intended by the appended claims to cover any and all such applications, modifications and embodiments within the scope of the present invention.

Accordingly,

What is claimed is:

1. A method for fabricating a multi-dimensional, micro-electromechanical assembly comprising the steps of:
providing a surface;
mounting at least one substantially planar structure on said surface in a first orientation;
providing a phase change material on said structure; and
inducing a phase change in said phase change material whereby said phase change material changes from a first state, in which said structure is disposed in said first orientation, to a second state, in which said structure is disposed in a second orientation.

2. The invention of claim 1 wherein said phase change material is solder.

3. The invention of claim 2 wherein said step of inducing a phase change in said phase change material includes the step up applying heat.

4. The invention of claim 1 wherein the step of mounting at least one substantially planar structure includes the step of mounting plural substantially planar structures in said substantially parallel orientation.

5. The invention of claim 1 wherein said first orientation is substantially parallel with respect to at least one axis relative to said surface and said second orientation is substantially nonparallel with respect to said axis relative to said surface.

6. The invention of claim 1 wherein said surface is a substrate.

7. The invention of claim 1 wherein said surface is a structure.

8. A method for fabricating a multi-dimensional, micro-electromechanical assembly comprising the steps of:
providing a surface;
providing a phase change material on said surface;
mounting at least one substantially planar structure on said surface and at least partially on said phase change material in a first orientation; and
inducing a phase change in said phase change material whereby said phase change material changes from a first state, in which said structure is disposed in said first orientation, to a second state, in which said structure is disposed in a second orientation.

9. A multi-dimensional, micro-electromechanical assembly comprising:
a surface;
at least one substantially planar structure mounted on said surface in a first orientation; and
a phase change material disposed on said structure;
whereby when said phase change material changes from a first state to a second state, the orientation of said structure is changed from said first orientation to a second orientation.

10. The invention of claim 9 wherein said phase change material is solder.

11. The invention of claim 9 including plural planar structures mounted in said substantially parallel orientation.

12. The invention of claim 11 further including a hinge connecting each of said planar structures to said surface.

13. The invention of claim 12 further including a mechanical rotation limiter.

14. The invention of claim 13 wherein said mechanical rotation limiter is a kickstand.

15. The invention of claim 13 wherein said mechanical rotation limiter is a lock.

16. The invention of claim 9 wherein said first orientation is substantially parallel with respect to at least one axis relative to said surface and said second orientation is substantially nonparallel with respect to said axis relative to said surface.

17. The invention of claim 9 wherein said surface is a substrate.

18. The invention of claim 9 wherein said surface is a structure.

19. A multi-dimensional, micro-electromechanical assembly comprising:
a surface;
a phase change material disposed on said surface; and
at least one substantially planar structure mounted on said surface and at least partially on said phase change material in a first orientation;
whereby when said phase change material changes from a first state to a second state, the orientation of said structure is changed from said first orientation to a second orientation.

20. A multi-dimensional, micro-electromechanical assembly comprising:
a substrate;
plural substantially planar structures mounted at least partially on said substrate in a first orientation; and
solder disposed in predetermined positions on said structures;
whereby when said solder changes from a first state to a second state, the orientation of said structures are changed from said first orientation to a second orientation, said first orientation being substantially parallel with respect to at least one axis relative to said substrate and said second orientation being substantially nonparallel with respect to said axis relative to said substrate.
